(19) United States
(12) Patent Application Publication
(10) Pub. No.: US 2008/0141887 A1
(43) Pub. Date: Jun. 19, 2008

(54) Method for making a distinguishable mark on objects

(76) Inventor: Ping Wen Huang, Wurih Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/529,220

(22) Filed: Sep. 29, 2006

(51) Int. Cl. B41F 23/04

(52) U.S. Cl. 101/487

(57) ABSTRACT

A method for making distinguishable mark on objects includes a step of making an annular groove in an outer surface of an object; a step of connecting a ring in the annular groove, and a step of heating and shrinking the ring to shrink the ring which is securely engaged with the annular groove. The ring can be printed with brand name, specifications or module number.

### FIELD OF THE INVENTION

The present invention relates to a method for connecting a shrinkable ring on an object and the ring includes specific color and/or marks.

### BACKGROUND OF THE INVENTION

A conventional screw bit 7 is shown in FIG. 4 and generally includes colored mark 71 painted thereon by which the users can tell the size or other information that the manufacturers want the users to know. However, the colored mark 71 can be easily scrubbed out by friction with other parts. FIG. 5 shows an improved colored mark 82 on a screw bit 8, wherein the screw bit 8 includes an annular groove 81 defined therein and the colored mark 82 is then printed on the outer surface of the annular groove 81. Although the colored mark 82 is located on the outer surface of the annular groove 81 and can be avoid from frequent friction, the colored mark 82 still fades out or be scrubbed out with other screw bits during storage. Because the colored mark 71/82 is a thin layer of paint so that once it is scrubbed, the thin layer of the paint is gone.

The present invention intends to provide a method for making a distinguishable mark on objects and the mark is made by Poly-Propylene (PP) or Polyvinyl Chloride (PVC) which can be shrunk and secured on the object. The mark cannot be easily scrubbed out by friction.

### SUMMARY OF THE INVENTION

The present invention relates to a method for making distinguishable mark on objects and the method comprises at least the following steps:

step (a): making an annular groove in an outer surface of an object;

step (b): connecting a ring in the annular groove, the ring being made by shrinkable material, and

step (c): heating and shrinking the ring to shrink the ring which is securely engaged with the annular groove.

The primary object of the present invention is to provide a method to secure a distinguishable ring to an object wherein the ring provides necessary information of the object by its color and/or printed patterns or characters and is not easily scrubbed out.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the steps of the method of the present invention;

FIG. 2 shows the status of the objects and the rings in each step of the method of the present invention;

FIG. 3 is a perspective view to show that the method of the present invention is applied to a socket;

FIG. 4 shows a conventional colored mark painted on a screw bit, and

FIG. 5 shows another conventional colored mark painted on a screw bit.

### DETAILED DESCRIPTION OF THE PREFERRED EMBODIMENT

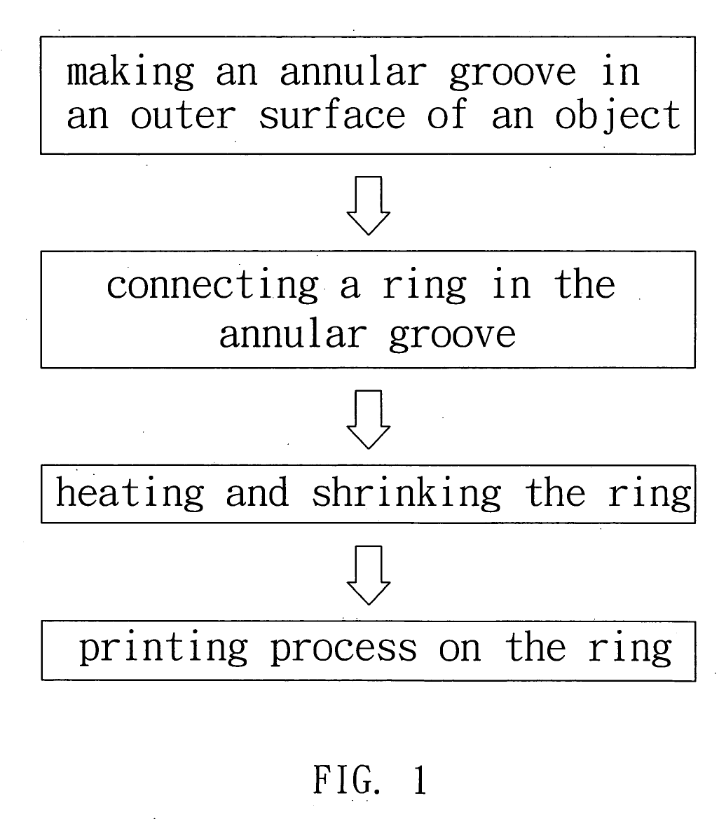

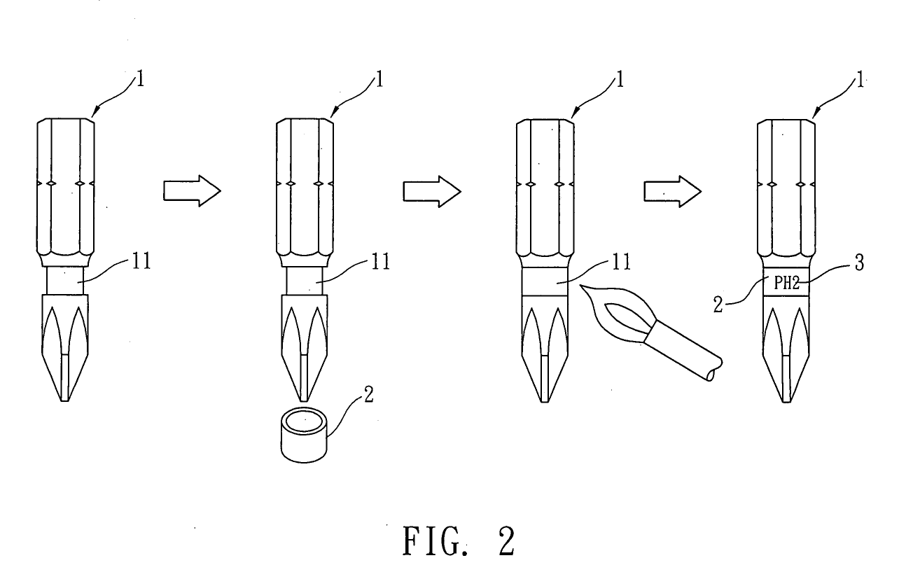

Referring to FIGS. 1 and 2, the method for making distinguishable mark on objects of the present invention comprises the following steps:

step (a): making an annular groove 11 in an outer surface of an object 1 such as a screw bit;

step (b): connecting a ring 2 in the annular groove 11, the ring 2 being made by shrinkable material such as Poly-Propylene (PP) or Polyvinyl Chloride (PVC);

step (c): heating and shrinking the ring 2 to shrink the ring 2 which is then securely engaged with the annular groove 11, and step (d): printing at least one pattern/character 3 on the ring 2.

The ring 2 can be printed with brand name, specifications or module number. It is noted that the ring 2 is in flush with an outer surface of the object 1 so that the object 1 as shown in FIG. 2 has a smooth outer surface which means debris or grease will not be easily stock on the outer surface of the object to cover the pattern/character on the ring 2.

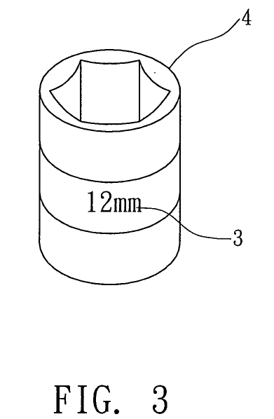

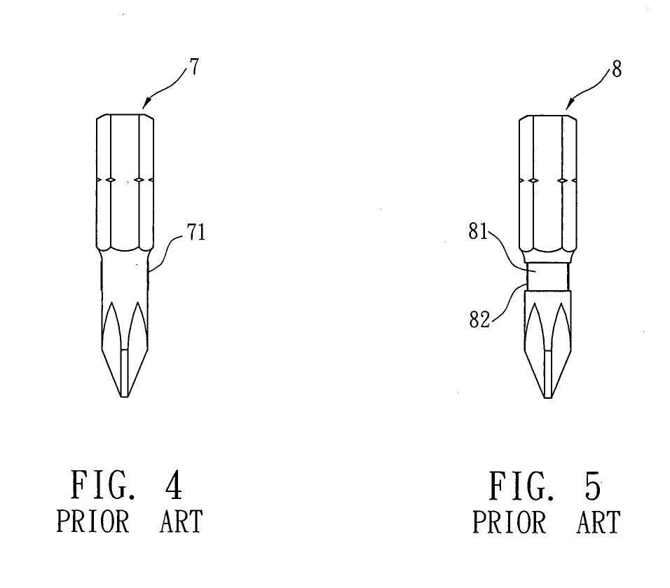

FIG. 3 shows that the method of the present invention can be applied to a socket 4 and the pattern/character 3 can be the specification of the socket 4.

While we have shown and described the embodiment in accordance with the present invention, it should be clear to those skilled in the art that further embodiments may be made without departing from the scope of the present invention.

What is claimed is:

1. A method for making distinguishable mark on objects, comprising:
step (a): making an annular groove (11) in an outer surface of an object (1);
step (b): connecting a ring (2) in the annular groove (11), the ring (2) being made by shrinkable material, and
step (c): heating and shrinking the ring (2) to shrink the ring (2) which is securely engaged with the annular groove (11).

2. The method as claimed in claim 1, wherein the object (1) is a screw bit.

3. The method as claimed in claim 1, wherein the shrinkable material is Poly-Propylene (PP).

4. The method as claimed in claim 1, wherein the shrinkable material is Polyvinyl Chloride (PVC).

5. The method as claimed in claim 1 further comprising a step (d) which includes a printing process on the ring (2).

6. The method as claimed in claim 5, wherein the printing process prints at least one pattern/character (3) on the ring (2).

7. The method as claimed in claim 1, wherein the ring (2) is in flush with an outer surface of the object (1).
